(19) United States
(12) Patent Application Publication
(10) Pub. No.: US 2003/0070078 A1
(43) Pub. Date: Apr. 10, 2003

(54) Method and apparatus for adding security to online transactions using ordinary credit cards

(76) Inventors: David F. Nosrati, Encino, CA (US); Datta Goutam, Chatsworthy, CA (US)

Correspondence Address: LEONARD TACHNER, A PROFESSIONAL LAW CORPORATION, SUITE 38-E, 17961 SKY PARK CIRCLE, IRVINE, CA, 92614-6364, US

(21) Appl. No.: 10/256,513

(22) Filed: Sep. 27, 2002

Related U.S. Application Data
(60) Provisional application No. 60/327,658, filed on Oct. 8, 2001.

(51) Int. Cl. H04L 9/00

(52) U.S. Cl. 713/185; 705/67

(57) ABSTRACT

A secure credit/debit card is identical to an ordinary credit/debit card in terms of dimensions and functionality. A user can use this card at a business vendor's location by swiping the card on a conventional credit card reader and signing the receipt. The only distinguishing feature of this card is that its account number contains a unique string of digits. Each secure credit/debit card is assigned an electronic identification device that is carried by the user of the card. When a user, attempting to make online payment using a network access device (computer, cell phone, personal digital assistant, etc.), types in the account number and the expiration date of a secure credit/debit card, the online vendor's server computer recognizes the aforementioned unique string of digits in the account number and requests the credit/debit card issuing bank's server computer to approve the transaction. The bank will approve the transaction only after it is able to verify the presence of the user's electronic identification device in the vicinity of the user's network access device.

### RELATION TO OTHER APPLICATIONS

This application takes priority from provisional application No. 60/327,658 filed on Oct. 10, 2001.

### BACKGROUND OF THE INVENTION

1. Field of the Invention

The present invention relates generally to the field of security in online, credit/debit card-based transactions. The invention relates more specifically to such transactions using an electronic identification device correlated to the credit/debit card via encryption and decryption to authenticate the user.

2. Background Art

The advent of the Internet has made it much simpler to commit credit/debit card fraud. A criminal can anonymously charge against a credit/debit card by simply typing in the account number and the expiration date.

Recognizing the problem, several companies have proposed different solutions to prevent frauds. However, none of these solutions has been widely accepted because they are either too inconvenient or require a new infrastructure such as installment of smart card readers.

### SUMMARY OF THE INVENTION

The apparatus of the preferred embodiment comprises the following components:

Public Key/Private Key

These are a pair of keys (passwords) used for encryption and decryption. These keys are related but access to only one key does not allow the other key to be deciphered. If a piece of information is encrypted using a public key, it can only be decrypted using the corresponding private key and vice versa. When a user wants to exchange secure information with someone, she gives out her public key while keeping her private key to herself.

Electronic Identification Device

This is a small electronic device that can be conveniently carried by a person (in a key ring or a wallet, for example) and used to identify its user to various electronic systems. This device carries the private key of the user and has the ability to perform encryption and decryption. Optionally, it can also contain the public key and other personal information (name, address, phone number, etc.) so that the user can conveniently transfer that information to the persons and systems she wants to communicate with.

Secure Credit/Debit Card

This card is identical to an ordinary credit/debit card in terms of dimensions and functionality. The only distinguishing feature of this card is its unique account number. A unique string of digits in the account number (prefix, suffix or a string anywhere in the middle) identifies this card as a secure credit/debit card.

Network Access Device

This device (computer, cell phone, personal digital assistant, etc.) can be used to connect to a network (e.g. Internet) and make online payments. In the preferred configuration, this device has built-in capability to remotely communicate with multiple electronic identification devices.

Additional Access Device

If the network access device does not have built-in capability to remotely communicate with user's electronic identification devices, an additional access device will be required to act as a communication bridge between the network access device and user's electronic identification devices. This device is either physically connected to the network access device or has the ability to remotely communicate with the network access device. This device also has the ability to remotely communicate with users' electronic identification devices. This additional access device can take one of the following forms: 1) a computer peripheral (mouse, keyboard, etc.), 2) a dongle that plugs into an external port of the network access device (USB, PS2, serial port, parallel port, etc.) and 3) a card (PCI, PCMCIA, etc.) that plugs into a bus slot of the network access device.

The method of the preferred embodiment comprises the process steps carried out in either of two alternative authentication operations using the aforementioned apparatus.

A bank that issues credit/debit cards creates a new secure account type wherein all account numbers contain a unique string of digits. These cards look and feel like any ordinary credit/debit card. The unique string of digits in the account number is the only distinguishing characteristic. A person can use such a credit/debit card at a business vendor's location by swiping the card on a conventional credit card reader and signing the receipt.

When a person attempts to use this credit card for an online transaction, the vendor will recognize the unique string of digits and must request the card-issuing bank to approve the transaction. A person's identity is verified online using an electronic identification device that is carried on the person. The bank must verify the presence of the electronic device, belonging to the rightful owner of the secure credit/debit card, before the online transaction can be approved.

### OBJECTS OF THE INVENTION

An object of this invention is to provide a method of adding security to online transactions using ordinary credit/debit cards that can prevent an unauthorized user from using a credit/debit card online by simply typing in the account number and the expiration date.

Another object of this invention is to provide a method of adding security to online transactions using ordinary credit/debit cards, the method being entirely automated and convenient for both businesses and consumers.

Still another object of this invention is to provide a method of adding security to online transactions using ordinary credit/debit cards and that does not require a significant change in infrastructure such as installment of smart card readers.

These objects, as well as other objects that will become apparent from the discussion that follows, are achieved, according to the present invention, by implementing the illustrated embodiments of the invention the details of which are provided hereinafter:

### BRIEF DESCRIPTION OF THE DRAWINGS

The aforementioned objects and advantages of the present invention, as well as additional objects and advantages thereof, will be more fully understood hereinafter as a result of a detailed description of a preferred embodiment when taken in conjunction with the following drawings in which:

FIG. 1 is a flow chart of the general operational steps of the preferred embodiment;

FIG. 2 is a flow chart of the preferred authentication process; and

FIG. 3 is a flow chart of an alternative authentication process also following the principles of the invention.

### DETAILED DESCRIPTION OF THE PREFERRED EMBODIMENT

The preferred embodiment of the present invention utilizes the following electronic components:

A small electronic identification device that can be carried by a person. This device contains the person's private key and has the ability to perform encryption and decryption.

A personal computer or other network access device that allows a person to make online payments.

An additional access device that may be required to allow the identification device to remotely communicate with a computer or other network access device.

A secure credit/debit card is identical to an ordinary credit/debit card in terms of dimensions and functionality. A user can use this card at a business vendor's location by swiping the card on a conventional credit card reader and signing the receipt. The only distinguishing feature of this card is that its account number contains a unique string of digits. Each secure credit/debit card is assigned an electronic identification device that is carried by the user of the card. When a user, attempting to make online payment using a network access device (computer, cell phone, personal digital assistant, etc.), types in the account number and the expiration date of a secure credit/debit card, the online vendor's server computer recognizes the aforementioned unique string of digits in the account number and requests the credit/debit card issuing bank's server computer to approve the transaction. The bank will approve the transaction only after it is able to verify the presence of the user's electronic identification device in the vicinity of the user's network access device.

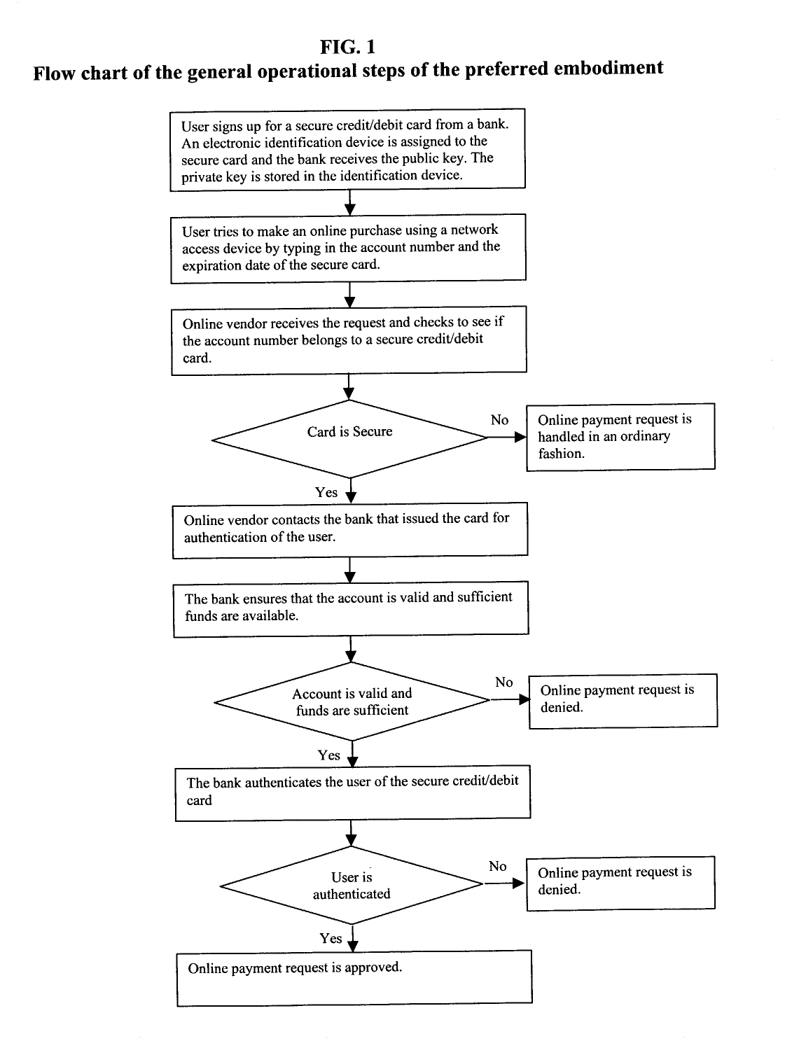

The invention may be more fully understood by referring to the appended flow chart drawings of FIGS. 1, 2 and 3. In FIG. 1, in the first step the user signs up for a secure credit/debit card from a bank. An electronic identification device is assigned to the secure card and the bank receives the public key. The private key is stored in the identification device. In the second step, the user tries to make an online purchase using a network access device by typing in the account number and the expiration date of the secure card. In the third step, the online vendor receives the request and checks to see if the account number belongs to a secure credit/debit card. If the card is not secure, the online payment request is handled in an ordinary fashion. If the card is secure, the online vendor contacts the bank that issued the card for authentication of the user. In the next step, the bank ensures that the account is valid and sufficient funds are available. If the account is either not valid or funds are not available, the online payment request is denied. Otherwise, the bank authenticates the user of the secure credit/debit card. If the user cannot be authenticated, the online payment request is denied. If the user is authenticated, the online payment request is approved.

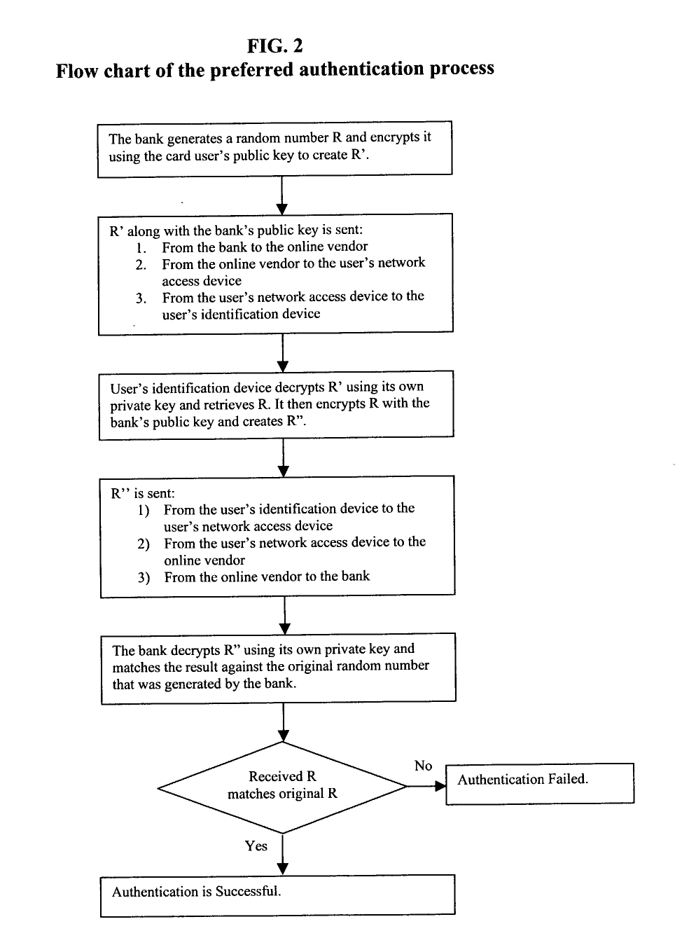

Referring to FIG. 2, it will be seen that the preferred embodiment of the authentication process comprises these steps: In the first step, the bank generates a random number R and encrypts it using the card user's public key to create R′. Then R′, along with the bank's public key is sent:

1. From the bank to the online vendor;

2. From the online vendor to the user's network access device;

3. From the user's network access device to the user's identification device.

Then the user's identification device decrypts R′ using its own private key and retrieves R. It then encrypts R with the bank's public key and creates R″. Then R″ is sent:

1. From the user's identification device to the user's network access device;

2. From the user's network access device to the online vendor;

3. From the online vendor to the bank.

The bank then decrypts R″ using its own private key and matches the result against the original random number that was generated by the bank. If the received R matches the original R, the authentication has succeeded; otherwise, it has failed.

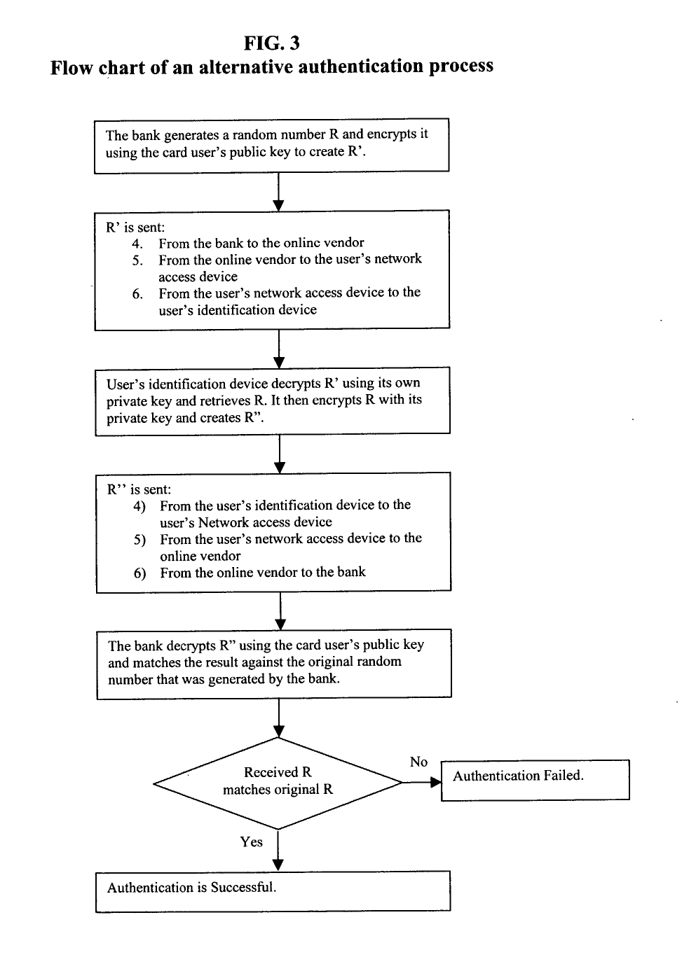

In a modified version of the authentication process shown in FIG. 3, the process comprises these steps: In the first step, the bank generates a random number R and encrypts it using the card user's public key to create R′. Then R′ is sent:

1. From the bank to the online vendor;

2. From the online vendor to the user's network access device;

3. From the user's network access device to the user's identification device.

Then the user's identification device decrypts R′ using its own private key and retrieves R. It then encrypts R with its private key and creates R″. Then R″ is sent:

1. From the user's identification device to the user's Network access device;

2. From the user's network access device to the online vendor;

3. From the online vendor to the bank.

Then the bank decrypts R″ using the card user's public key and matches the result against the original random number that was generate by the bank. If received R matches the original R, authentication has succeeded; otherwise, it has failed.

Based upon the foregoing, it will be understood that the present invention provides the following:

1. A secure credit/debit card that is identified as such by a unique string of digits in the account number that is printed on the card.

2. Each secure credit/debit card is assigned an electronic identification device that the card user must carry on her person when she wants to make online payments using the secure credit/debit card.

3. A secure credit/debit card can be used as a conventional card at a merchant location by swiping the card on a conventional card reader and typing a PIN or signing a receipt.

4. When a secure credit/debit card is used to make an online payment, the online vendor recognizes the secure credit card because of the unique string of digits in the account number and contacts the bank that issued the card.

5. When a secure credit card is used to make an online payment, the issuing bank will only accept the payment if it can verify the presence of the electronic identification device assigned to the secure credit/debit card in the vicinity of the card user's network access device.

6. The bank verifies the presence of the card user's electronic identification device by executing a public/private key exchange protocol.

Having thus disclosed a preferred embodiment of the invention, those having skill in the relevant art will now perceive various additions and modifications which may be made to the invention. Accordingly, it will be understood that the invention is limited only by the appended claims and their equivalents.

We claim:

1. A credit card system for conducting online transactions with increased security; the credit card system comprising:
at least one credit card having at least one unique string of digits identifying the card as a secure card associated with a unique corresponding identification number;
an electronic identification device storing said identification number and having encrypting and decrypting capability; and
a network access device communicating with said electronic identification device and enabling access to remote online sites where said transactions are to be conducted.

2. The credit card system recited in claim 1 wherein said network access device comprises a personal computer.

3. The credit card system recited in claim 1 wherein said network access device comprises a personal digital assistant.

4. The credit card system recited in claim 1 wherein said network access device comprises a cell phone.

5. The credit card system recited in claim 1 wherein said electronic identification device comprises means for decrypting a received random number using said identification number as a private key.

6. The credit card system recited in claim 5 wherein said electronic identification device comprises means for encrypting said received random number for transmission over said network.

7. A debit card system for conducting online transactions with increased security; the debit card system comprising:
at least one debit card having at least one unique string of digits identifying the card as a secure card associated with a unique corresponding identification number;
an electronic identification device storing said identification number and having encrypting and decrypting capability; and
a network access device communicating with said electronic identification device and enabling access to remote online sites where said transactions are to be conducted.

8. The debit card system recited in claim 1 wherein said network access device comprises a personal computer.

9. The debit card system recited in claim 1 wherein said network access device comprises a personal digital assistant.

10. The debit card system recited in claim 1 wherein said network access device comprises a cell phone.

11. The debit card system recited in claim 1 wherein said electronic identification device comprises means for decrypting a received random number using said identification number as a private key.

12. The debit card system recited in claim 5 wherein said electronic identification device comprises means for encrypting said received random number for transmission over said network.

13. A method of providing authentication for an online credit card transaction; the method comprising the steps of:
providing a credit card having at least one unique string of digits;
assigning a unique identification number corresponding to said unique string of digits;
storing said identification number in an electronic identification device;
generating a random number for said transaction from an approval entity online and encrypting said random number;
transmitting said encrypted random number to said electronic identification device;
using said identification number to decrypt said random number at said device;
encrypting said random number with a public key and transmitting said public key encrypted random number to said approval entity online;
decrypting said public key encrypted random number and comparing said decrypted public key encrypted random number with said generated random number; and
approving said transaction only if said comparing results in a match.

14. A method of providing authentication for an online credit card transaction; the method comprising the steps of:
providing a credit card having at least one unique string of digits;
assigning a unique identification number corresponding to said unique string of digits;
storing said identification number in an electronic identification device;
generating a random number for said transaction from an approval entity online and encrypting said random number;
transmitting said encrypted random number to said electronic identification device;
using said identification number to decrypt said random number at said device;
encrypting said random number with a identification number and transmitting said identification number encrypted random number to said approval entity online;
decrypting said identification number encrypted random number and comparing said decrypted identification number encrypted random number with said generated random number; and
approving said transaction only if said comparing results in a match.
